(19) United States
(12) Patent Application Publication
(10) Pub. No.: US 2002/0077946 A1
(43) Pub. Date: Jun. 20, 2002

(54) Method and apparatus for tracking and evaluating the performance of financial analysts

(76) Inventors: Russell L. Caplan, Arlington, VA (US); Charles Chehebar, Briarcliff Manor, NY (US)

Correspondence Address: PENNIE & EDMONDS LLP, 1667 K STREET NW, SUITE 1000, WASHINGTON, DC, 20006

(21) Appl. No.: 09/734,763

(22) Filed: Dec. 13, 2000

(51) Int. Cl. G06F 17/60

(52) U.S. Cl. 705/36

(57) ABSTRACT

A web site for licensed investment analysts who wish to demonstrate their abilities to select a portfolio of investment instruments is made available to users. The licensed investment analysts are qualified through their respective investment firms so as to establish eligibility to participate in the web site as licensed investment analysts. The licensed investment analysts select investment portfolio characteristics such as the type of investment, the industry sector(s) that is (are) the focus of that portfolio, and an investment risk level. A registered licensed investment analyst is given a predetermined sum of fictional money to invest in a portfolio consonant with the portfolio characteristics that had been established at that analyst's own choosing. Once a portfolio is established, a licensed investment analyst may modify the portfolio by trading as often as he or she wishes. A user visiting the web site is able to view each licensed investment analyst's portfolio balance and view the history of trades made by that analyst. A user may also optionally contact the analyst or that analyst's investment firm for further information. In addition to licensed investment analysts, the web site also accommodates portfolios selected by participating business students who are enrolled at business schools. For all such participants, more than one portfolio may be established, each portfolio corresponding to a different set of investment portfolio characteristics.

### RELATED APPLICATIONS

There are no related applications.

### FIELD OF THE INVENTION

The present invention is directed to a web site which provides information to the public about the relative abilities of investment firms and investment analysts in one or more investment specialties.

### BACKGROUND OF THE INVENTION

The Internet has increasingly been used for communications between computers which operate in a client-server relationship. FIG. 15 shows a simplified schematic of an overall architecture in which the Internet 1000 is the centerpiece of a data communications network. In this context, at least one server computer 1002 is connected to the Internet in a known manner, as is at least one client computer 1004.

The server computer 1002 illustratively comprises a processor, a disk drive, a memory such as a semiconductor memory, and runs an operating system such as Windows-NT or Linux. The server computer 1000 is additionally equipped with a data communications device such as a network card or gateway to connect to the Internet 1000. In general, the connection to the Internet 1000 can be established via an Internet Service Provider (ISP) or a direct connection. In a preferred embodiment, the server computer 1000 is connected to the Internet 1000 via a high-speed connection such as a Digital Subscriber Line connection or a T1 connection, or the like, in order to receive and service numerous requests at a high data rate.

In addition, the server computer 1000 is configured to function as a web server. The web server is typically a general purpose computer such as the server computer running software such as Common Gateway Interface (CGI) programs. The CGI programs provide for communication and interaction between a client computer 1004 and the server computer 1002 via the Internet 1000. These CGI programs, coupled with data communications software programs, are configured to receive packets of messages from computers connected to the Internet 1000, decipher the information in the packets, and act according to instructions provided in the packets within the constraints imposed by an administrator managing the server computer 1002. Commercial suppliers such as Netscape Corporation market web server software. Additionally, such web server software can also be downloaded and configured free of charge from other sources. Persons skilled in the art understand how to write CGI programs in programming languages such as UNIX Shell script, Perl, C, C++, Java and others.

In addition to performing the tasks of receiving and sending packets of data to and from the computers connected to the Internet, the CGI programs are configured to perform other tasks such as communicate with a database 1006 coupled to the server computer 1002, and extract or store information in the database according to the software instructions provided within the server computer 1002 or in the packets received from the Internet 1000. The server computer 1002 is configured to receive request messages from a client computer 1004 over the Internet in the Hyper Text Transfer Protocol (HTTP), File Transfer Protocol (FTP) or any similar protocol used to transfer data, video, voice or a combination of these media. After analyzing the request messages, the server computer 1002 is configured to transmit in response messages that include “web pages” that are programmed in Hyper Text Markup Language (HTML) or a similar language. Embedded in the web pages are components such as documents, scripts, objects, and frames that enable the server computer 1002 to display colorful graphical images on a display device coupled to the client computer 1004. Persons skilled in the art know how to make web pages using programming languages or tools such as HTML, Cold Fusion, Java, Java Script, Active Server Pages, Dynamic HTML, Extensible Markup Language (XML), etc.

Database 1006 stores information using, for example, an Oracle Relational Database Management System. The information stored in such a database may be provided by the entity operating the server. The database, however, can also be used to store information and requests made by the client computer, among others.

The client computer 1004 may be connected to the Internet either directly, or via an Internet service provider, as is known to those skilled in that art. The client computer may also belong to a network, such as a local area network having a gateway connection to the Internet. Each client computer 1004 illustratively comprises a microprocessor such as a Pentium III microprocessor, a magnetic, optical or other type of disk drive, a memory such as a semiconductor memory, a keyboard or other character input device, a mouse or other pointing device, and a display device such as a CRT or a flat panel display. In addition to operating system software, the client computer 1004 also executes a program called a web browser, or simply, a browser. The browser is a computer program that provides access to the vast resources of the Internet. Typically, this is done by providing a “window” to the data located on other computers connected to the Internet. Examples of browser programs available are Netscape Navigator and Microsoft Internet Explorer.

A number of web sites use the Internet to allow individuals operating client computers to demonstrate their ability to predict the performance of investment instruments, such as equities. The web site www.iexchange.com, for example, posts an analyst's name, that analyst's average return on selected investments, and identifies that analyst's latest stock picks. A user can choose to view the performances of analysts ranked according to one of several criteria, including a category devoted to individual professional analysts' average returns on their stocks.

### SUMMARY OF THE INVENTION

The present invention is realized by a method of providing information reflective of the performance of investment analysts in selecting and managing one or more portfolios of investment instruments. The method comprises the steps of receiving registration information from each of a plurality of investment analysts who purport to be affiliated with an investment firm or other entity; verifying that each of the investment analysts really is licensed and affiliated with the investment firm or entity that he/she has designated; receiving at least one set of investment portfolio characteristics from each investment analyst; accepting investment instrument choices to build a portfolio consonant with a corresponding at least one set of investment portfolio characteristics selected by that investment analysts, with each investment analyst being given a predetermined fictional dollar value to create an investment portfolio; and subsequently transferring information reflective of a then-current value of at least one portfolio.

In one aspect of the invention, a licensed investment analyst selects a particular industry sector as an investment characteristic. In another aspect of the invention, a licensed investment analyst selects an investment style reflective of risks of a portfolio which that licensed investment analyst wishes to assemble. In a further aspect of the invention, a licensed investment analyst selects the type of investment instrument (e.g., equities, bonds) as one of the portfolio characteristics.

In a further aspect of the invention, a licensed investment analyst is permitted to modify a portfolio by trading individual instruments which make up that portfolio.

In yet another aspect of the invention, users may view the history of one or more trades made by a licensed investment analyst in managing a particular portfolio.

### BRIEF DESCRIPTION OF THE DRAWINGS

The present invention can better be understood through the figures in which:

FIG. 1 depicts the home page of the web site in accordance with the present invention;

FIG. 2 presents an “analyst card”, presenting information about a licensed investment analyst registered with the web site;

FIG. 3 presents a modified web page of an investment firm having licensed investment analysts who are registered with the web site;

FIG. 4 presents a web page depicting the performance of a particular licensed investment analyst over a time period;

FIG. 5 is a web page providing a selection of criteria for grouping licensed investment analysts whose performance information is to be displayed;

FIG. 6A presents a web page showing the most widely held securities in the portfolios of the licensed investment analysts;

FIG. 6B shows an alternate representation of information similar to that shown in FIG. 6A;

FIG. 7 presents a web page showing the most widely sold securities in the portfolios of the licensed investment analysts;

FIG. 8 presents the performance of licensed investment analysts who have investment characteristics in common;

FIG. 9 presents the performance results of business school students who have investment characteristics in common;

FIG. 10 presents an analyst registration page;

FIG. 11 presents a user registration form;

FIG. 12 presents a clearinghouse directory page

FIG. 13 presents a clearinghouse analyst list;

FIG. 14 presents a clearinghouse message page; and

FIG. 15 presents a simplified schematic of a conventional data communications network including a client-server architecture using the Internet.

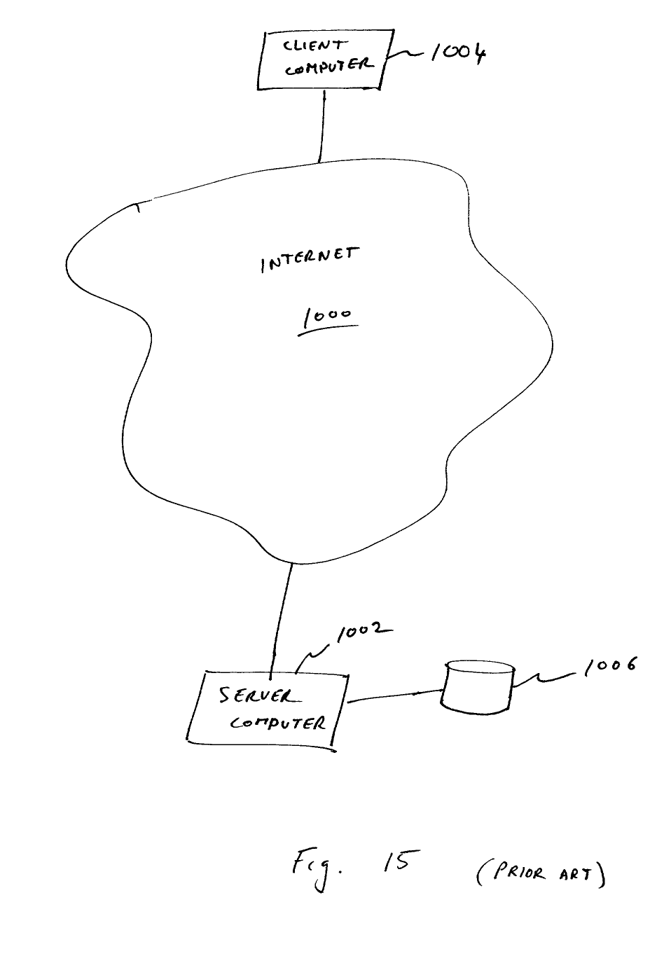

### DETAILED DESCRIPTION OF THE INVENTION

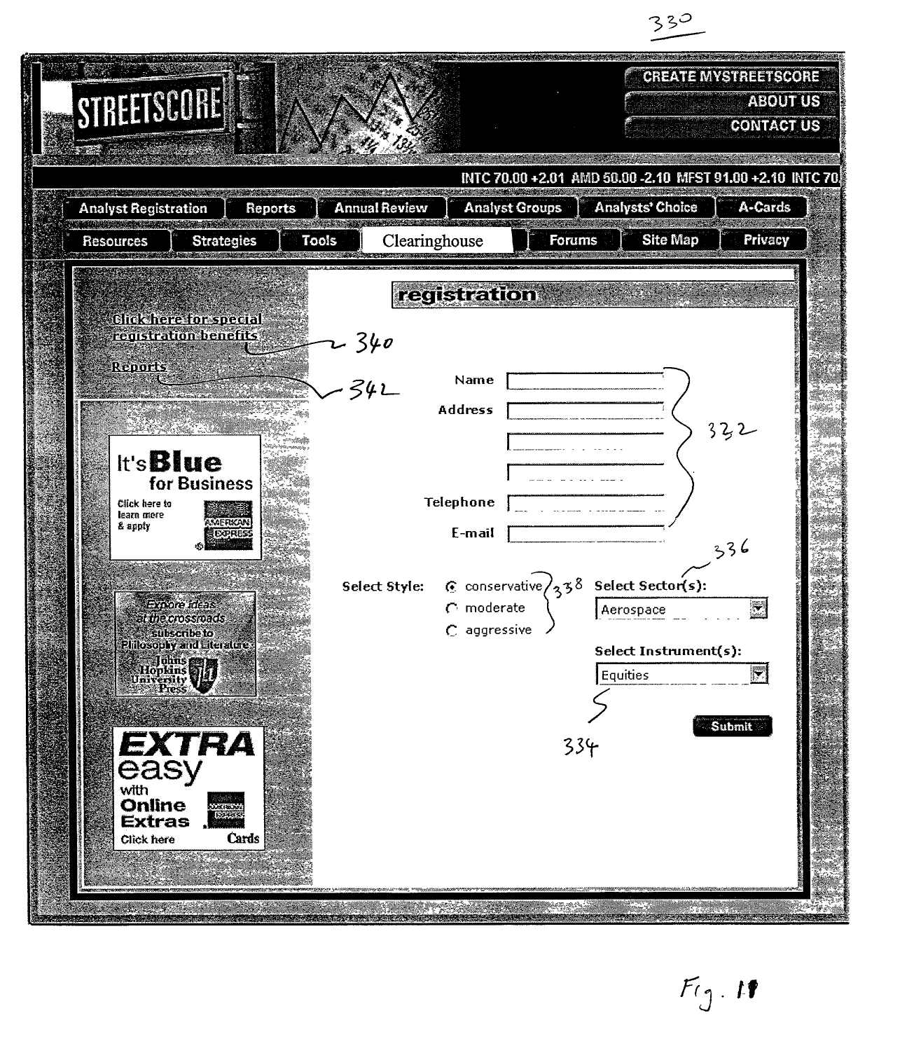

The present invention preferably is implemented the context of a web site using a client-server arrangement, not unlike that shown in FIG. 11. The web site in accordance with the present invention provides professional investment analysts a forum in which they can show off their skill at investing. A licensed investment analyst registers with the web site and provides identifying information, along with the name of the investment firm with which that analyst is affiliated. The affiliation is verified, such as by conferring with an online database arranged for in advance between the web site and the investment firm, or in some other known manner. The investment analyst then is provided with an opportunity to assemble at least one investment portfolio using a predetermined amount, say $100,000, of fictional money. The portfolio must be consistent with at least one investment portfolio characteristic selected by the investment analyst. The investment portfolio characteristics preferably include such categories as an investment style (conservative, moderate, aggressive), and industry sector, and an investment instrument type (equities, bonds, currency, futures, commodities, options, etc.).

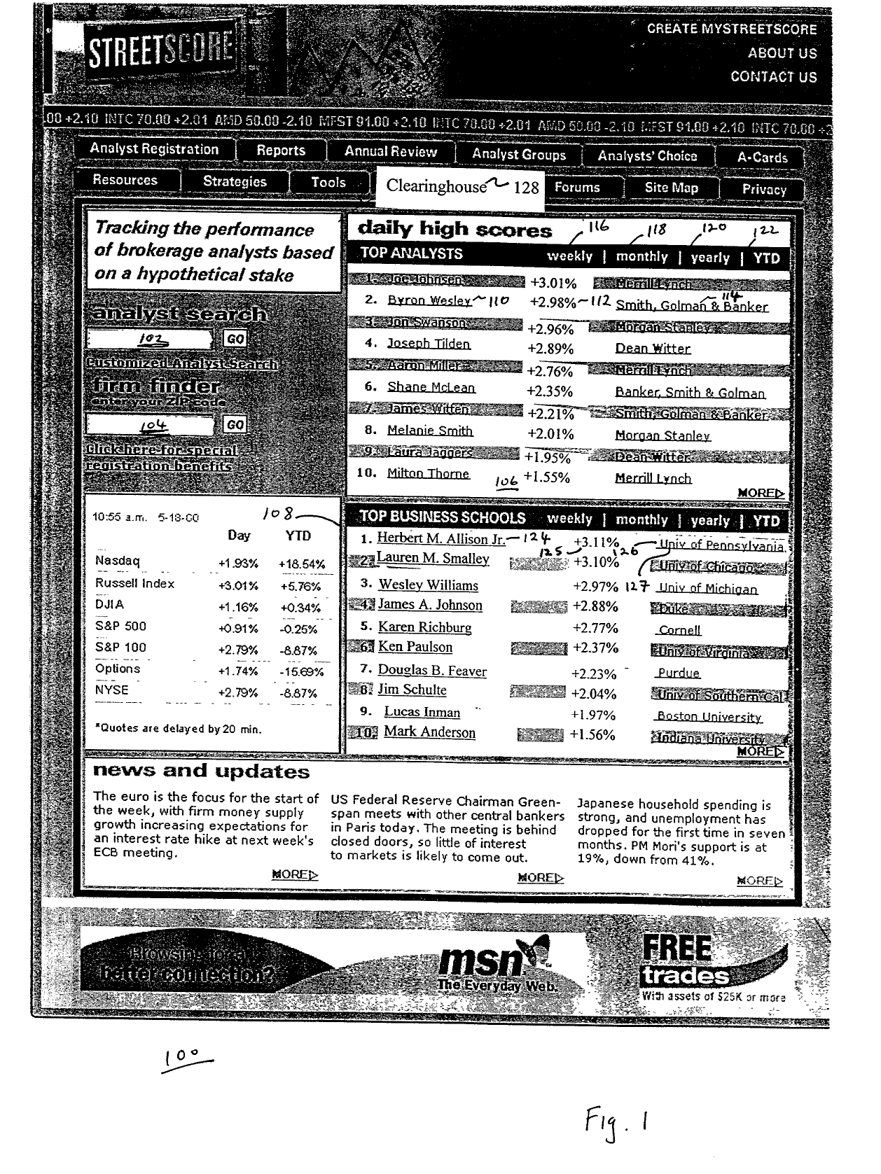

FIG. 1 shows the home page 100 for a web site in accordance with the present invention. A user receiving this web page is presented with an analyst name field 102 which allows the user to view the performance of a particular investment analyst registered with the web site. The user is also presented with a geographical location information field 104 in which the user may enter a zip code to locate investment firms and analysts who have registered with the web site and are within a predetermined radius of the entered zip code. The home page also presents a top investment analyst window 106 and a top business student analysts window 108.

The top analysts window 106 on the home page 100 presents the name 110, the performance 112 and the investment firm name 114 with which an investment analyst is associated. The performance 112 preferably represents that investment analyst's return over at least one of several different time periods. Choices are provided to view the return over a different time period such as a week 116, a month 118, a year 120 and a calendar year-to-date 122 by clicking on an appropriate button. By clicking on an analyst's name 110, the user is transferred to an “analyst card” page which profiles that analyst in further detail. Similarly, by clicking on the corresponding investment firm name 114, the user is switched to a page on the web site of the corresponding investment firm, where further information may be obtained. As seen in FIG. 1, the top analyst window 106 displays information about a predetermined number of analysts, in this case 10.

The top of the business student analysts window 108 presents the name 124, the performance 125, and the business school name 126 of a number of MBA students 124 who participate in the web site by assembling and trading components of fictional financial portfolios, not unlike the case with the professional investment analysts. The performance measures 125 for each MBA student 124 may be displayed over varying time periods, much like the case with the top analyst window 106. Clicking on the links 127 to a particular business school will transfer a user to a page of that business school where the user can learn more about the institution.

In windows 106, 108, the average returns for the individual analysts and MBA students are displayed. However, as an alternative, or in addition, one may display the investment firm (or business school) averages, based on the individual performances of their personnel who participate in the web site.

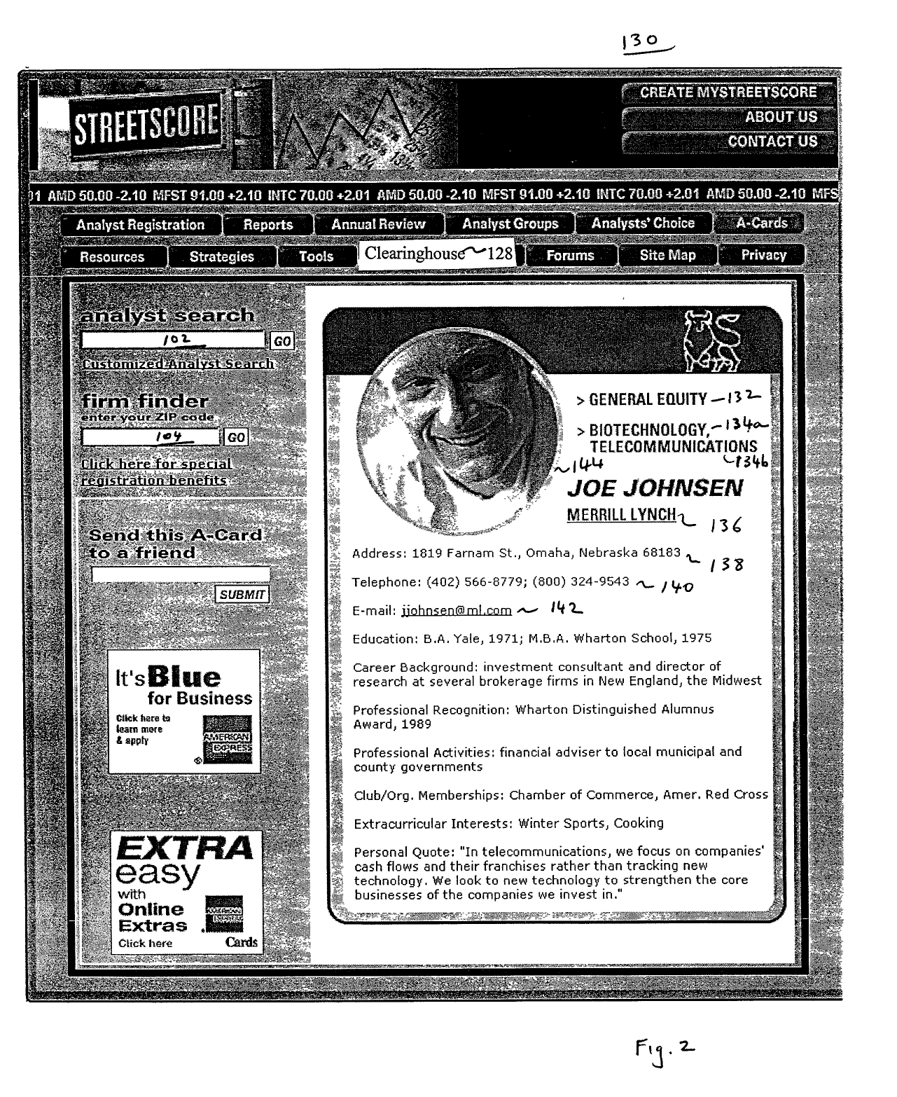

FIG. 2 shows an “analyst card” web page 130 to which a user is transferred upon clicking on the link 110 associated with the name of a particular licensed investment analyst. Web page 130 provides information on the investment instrument type(s) 132 (in this case, equities) that this licensed investment analyst specializes in for the purposes of the web site and also includes investment sector information 134a, 134b which reflects this licensed investment analyst's interests. In addition, analyst page 130 also provides a link to the investment firm 136 with which this licensed investment analyst is associated. Contact information including address 138, phone numbers 140 and email information 142 are included along with a brief biographical sketch of the licensed investment analyst. And because one of the purposes of this site is to urge users to contact analysts, a photograph of the licensed investment analyst 144 is also included.

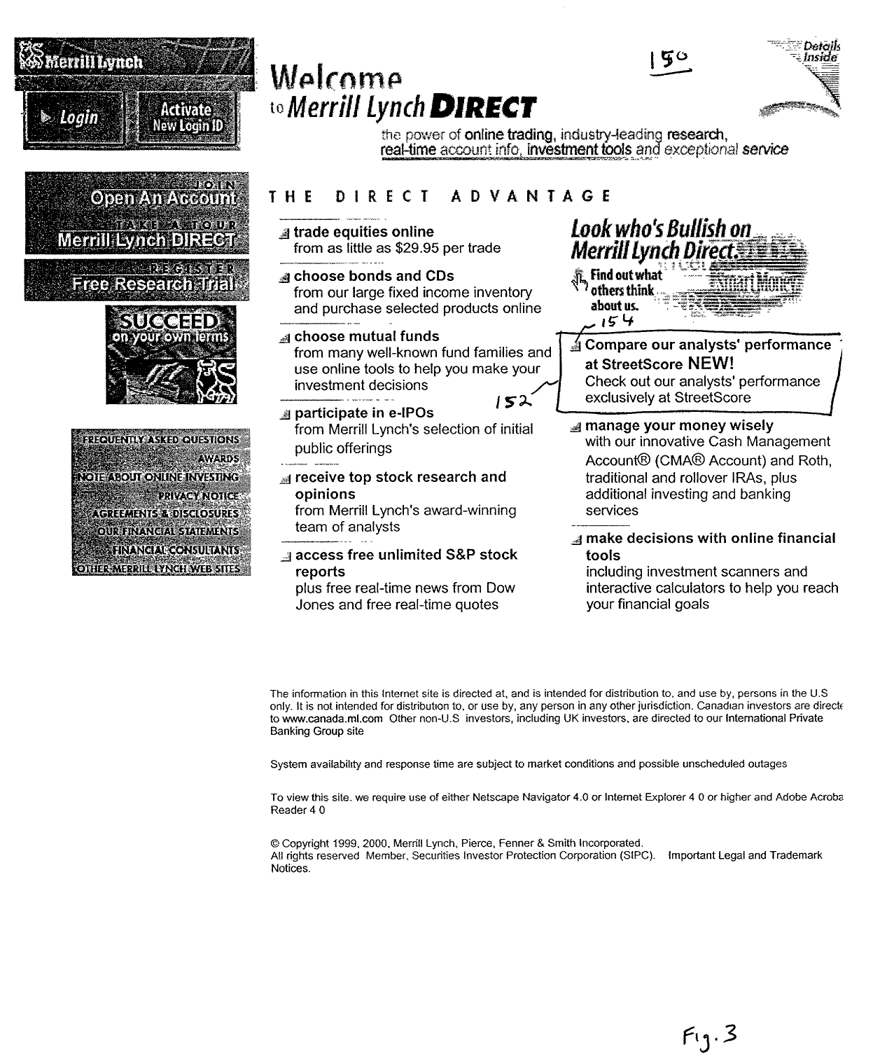

FIG. 3 shows an investment firm web page 150 to which a user is transferred upon clicking on the investment firm name link 114, 136. In this instance, clicking on these links 114, 136 puts a user in direct communication with the servers belonging to, or associated with, the investment firm, in this case Merrill Lynch. Included among the various choices on the investment firm's page 150 is promotional information 152 which invites a user to compare the performance of the investment firm's own licensed investment analysts who are registered with the web site, versus the average, or even individual, performances of licensed investment analysts associated with other firms, as kept track of by the host web site. Accordingly, a button 154 is provided for the user to obtain this comparative information. The purpose of information 152 and button 154 is to enable a participating investment firm to refer a visitor to that firm's own web page to information which hopefully will demonstrate the superior abilities of that firm's own analysts.

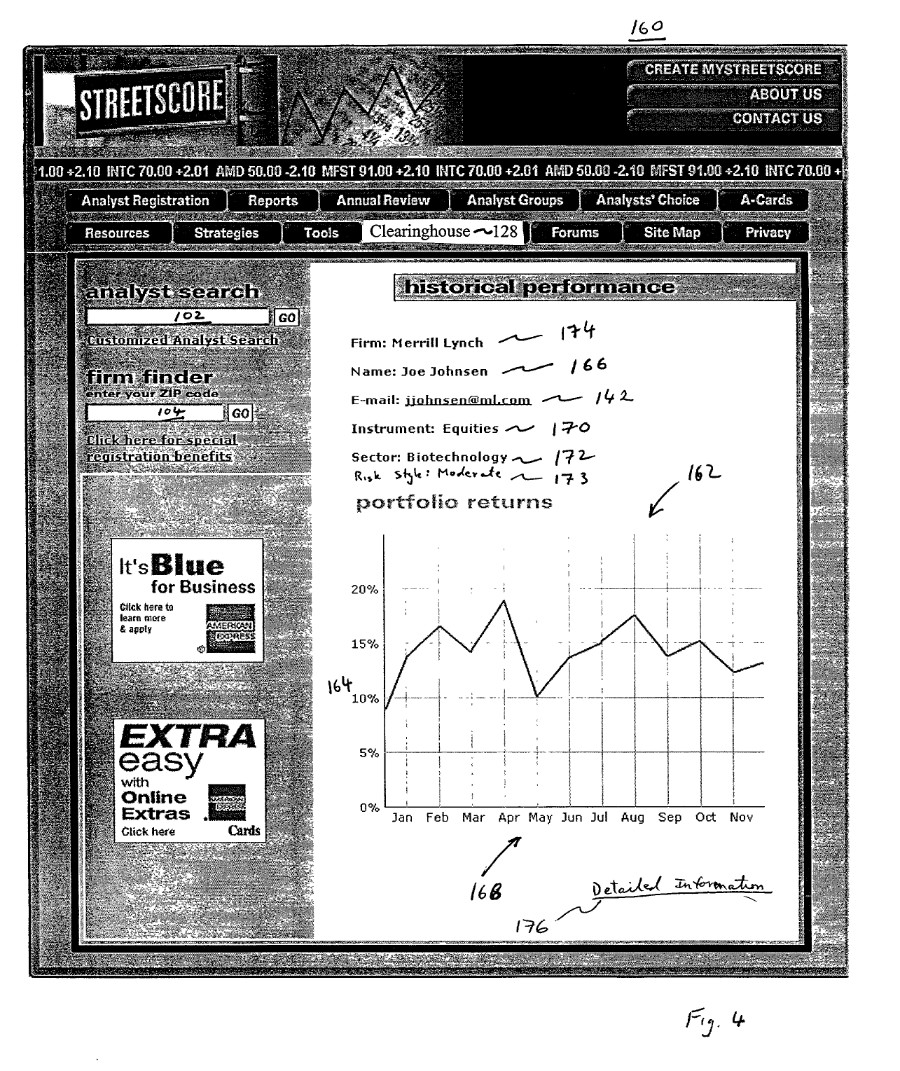

FIG. 4 presents a licensed investment analyst's historical performance web page 160. The analyst historical performance web page 160 provides a performance graph 162 which shows the returns 164 earned by a particular licensed investment analyst 166 during each of several discrete time periods 168. As seen in FIG. 4, the discrete time periods presented are individual months and the percentage returns 164 are presented for each of these months. It should be evident to one skilled in the art that return information may instead be plotted on a daily, weekly, or other basis. It should also be evident to one skilled in the art, that instead of a discrete return per time period, one may instead plot a cumulative return over some length of time. In addition to identifying the particular licensed investment analyst and presenting the return 162, FIG. 4 also presents the pertinent investment type 170, the investment sector 172 and the risk style 173 to which the performance graph pertains. Finally, also presented with this information is the investment firm name 174 with which the particular analyst 166 is associated.

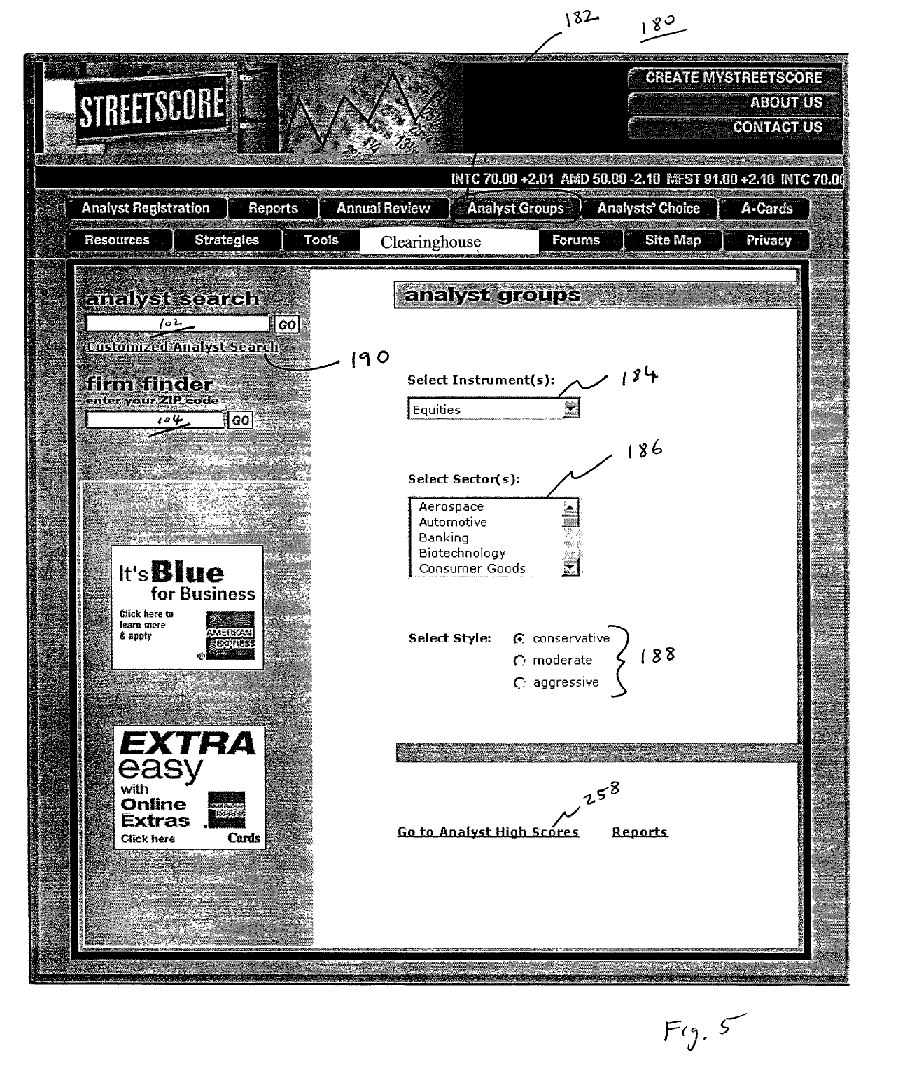

FIG. 5 presents a web page 180 to which a user is directed upon clicking the “analyst groups” button 182. The analyst groups button allows a user to select the investment portfolio characteristics of a particular group of analysts whose performances are to be viewed. Upon clicking button 182, the user is permitted to modify the specific instrument type in instrument window 184. Instrument window 184 allows a user to choose from among equities, bonds, currencies, futures, commodities, and options, among others. The user is also allowed to select an industry sector from sector window 186. Sector window 186 permits the user to select licensed investment analysts who focus on one from among several categories such as aerospace, automotive, banking, biotechnology, consumer goods and so forth. It should be evident to one skilled in the art that a wide variety of such industry sectors may be presented to the user to choose from. Finally, the user may select an investment style by clicking on one of the set of investment risk buttons 188. As seen in FIG. 5, the user may select from analysts who invest conservatively, undertake moderate risk, or are aggressive investors. In the context of the present invention, a determination as to conservative, moderate, or aggressive investment risk levels, is based upon the beta “β” of the portfolio selected by an analyst. Nominally, a conservative investment risk level is characterized by a beta less than 1; a moderate investment risk level is characterized by a beta between 1 and 1.2; and an aggressive investment risk level is characterized by a beta greater than 1.2. It should be kept in mind, however, that the above-mentioned beta cutoffs delineating the various risk levels are only exemplary, and thus may be changed, as desired.

A “customized analyst search” link 190 is provided for a customer to identify investment analysts or investment firms satisfying detailed user-specified criteria. Upon clicking on link 190, a page is transmitted to the user which allows the user to select one or more criteria, such as particular performance results, asset allocation scenarios for growth or value investing, particular industry sectors, geographical locations of the analysts or firms, and the like. Preferably, on such a page, the customer is further given the choice of using boolean functions of specified individual criteria to formulate a request to obtain collective information across all the analysts and firms from the database. Thus, for example, a user may search for analysts who have between a 20-30% return in both biotechnology and automotive sectors but not in any other sector. Alternatively, the user may search for investment firms which are located within a particular distance of a zip code and whose investment analysts, on average, have the highest investment performance. Other such combinations created by logical operators of individual criteria are also possible.

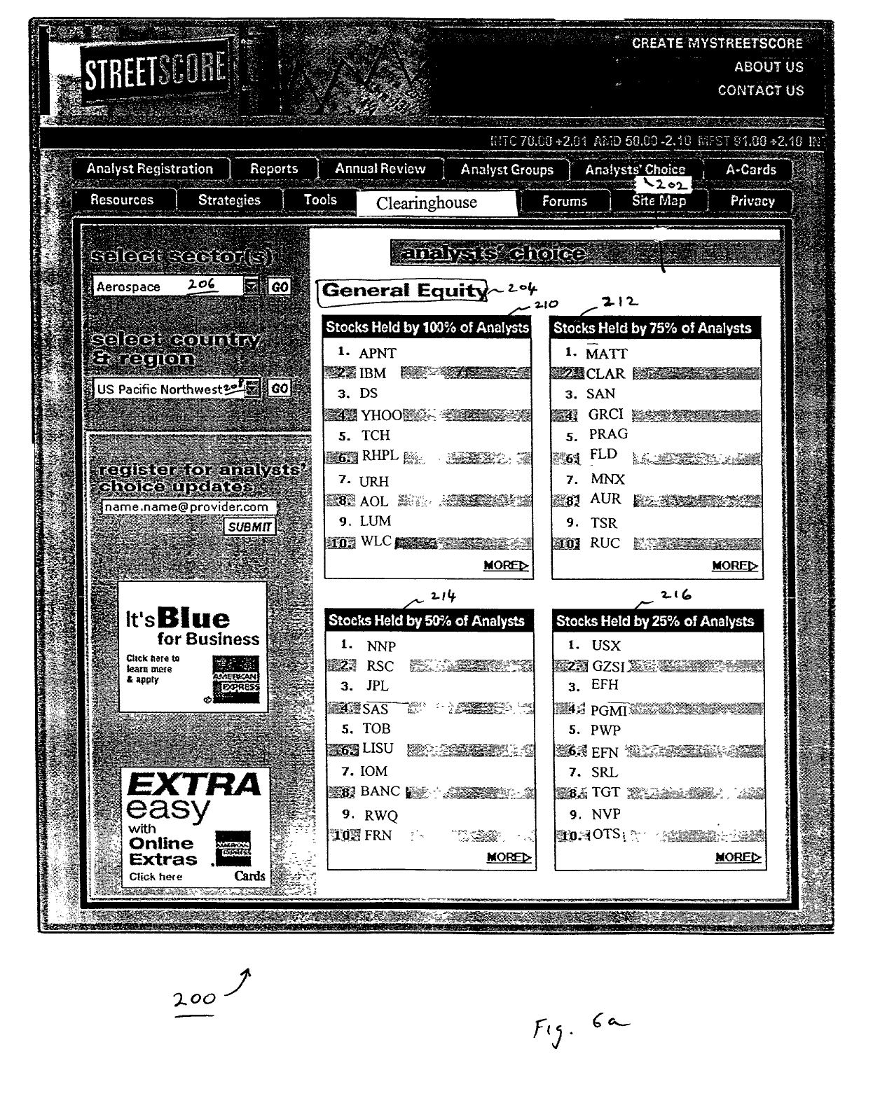

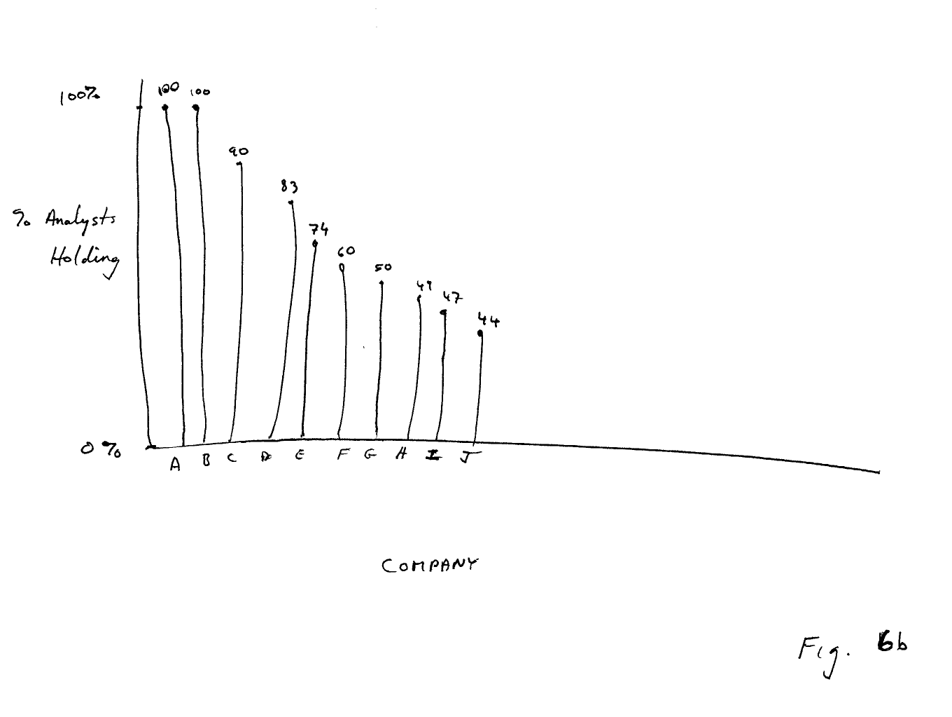

FIG. 6a shows an analysts' choice web page 200, which is displayed when a user selects the “analysts' choice” button 202. Web page 200 presents, in tabular form, the names of individual instruments held by a predetermined proportion (in this case, 75-100%, 50-75%, 25-50% and 0-25%) of the licensed investment analysts who are members of the web site. The investment instruments displayed on this page are determined by the investment portfolio characteristics such as investment type 204 and industry sector 206, and also by the region of the country 208 where the analysts reside. It should be kept in mind that fewer than all three of these criteria, or yet other criteria, may also be used to make this determination. As seen in FIG. 6a, Table 210 presents a list of companies whose shares are held by 75-100% of the licensed investment analysts. Similarly, tables 212, 214 and 216 list the companies whose shares are held by at least 50-75%, 25-50% and 0-25% respectively, of the licensed investment analysts. FIG. 6b shows an alternate representation of the analysts' choice information. In FIG. 6b, the y-axis represents the percentage of analysts holding shares in the companies identified along the x-axis, the companies being ranked in descending order as to the percentage of analysts holding shares of each. Thus, a visitor to the web site may request collective information concerning the current holdings across the portfolios of the investment analysts.

While FIGS. 6a and 6b simply identify the percentage of licensed investment analysts holding certain financial instruments belonging to various individual investment types (equities in FIGS. 6a & 6b), additional information about the various baskets of investments may be provided. For instance, the proportional representation of each individual investment type within each of the portfolios, may also be tabulated and presented to the user. Thus, one would be provided with not only the identity of the individual financial instruments in the various baskets, but also the dollar-value weighting, or proportion, of those financial instruments and, where applicable, instrument types in each of those baskets. This provides a user with information as to the importance of such a financial instrument among the various portfolios assembled by all the licensed investment analysts or other participants. For example, in the case of equity investments, if shares of IBM make up at least 20% of the value of each of the portfolios in which it is present, this information would be provided, in addition to the information about the percentage of analysts (or portfolios) in which it is a component. Such information can be displayed in many different ways, such as the plots seen in FIGS. 6a & 6b, as a percentage-level “slice” of a three-dimensional plot, or even on a two-dimensional rendition of a three-dimensional plot, showing names of individual equities on a first axis, percentage of portfolios including that equity on a second axis, and weighted percentage within the portfolios in which each equity appears on a third axis. Other textual and graphical representations may also be used. While these figures show plots for equities, it should be kept in mind that similar plots may be created for other financial instruments, as well.

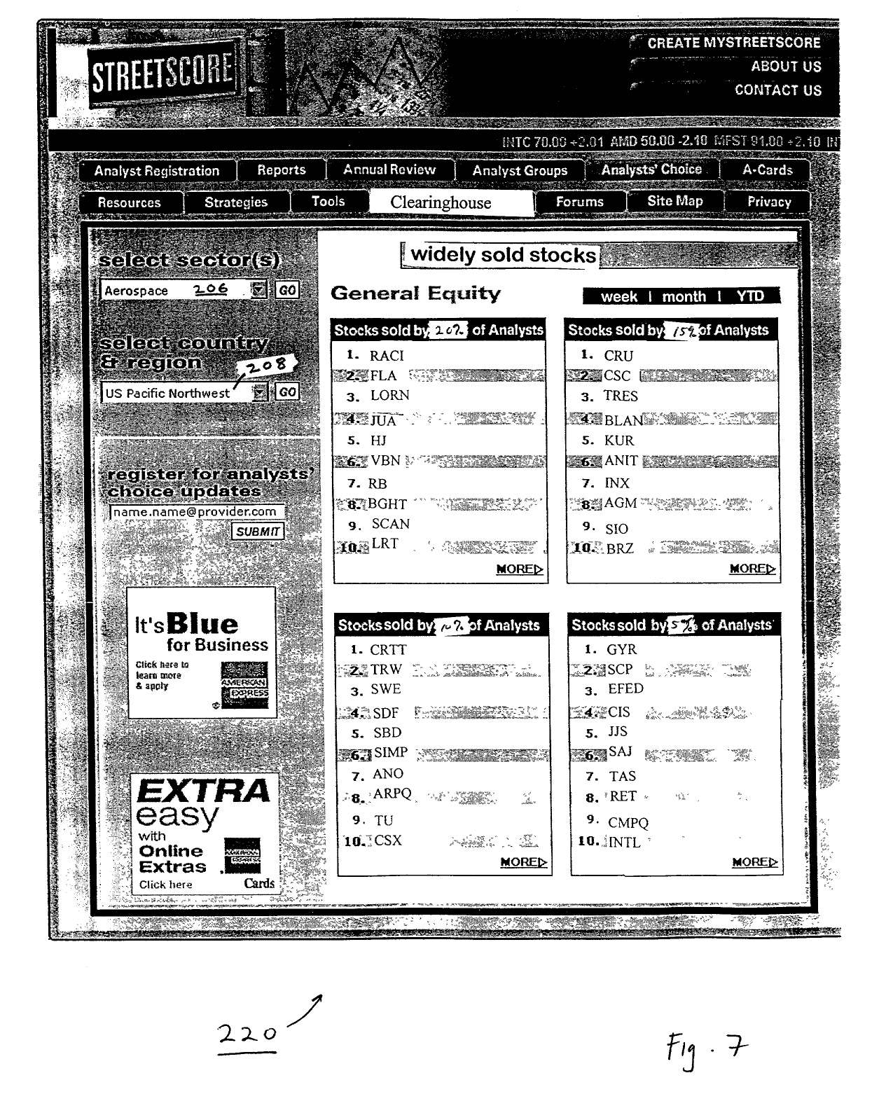

FIG. 7 depicts a “widely sold stock” page 220, which is displayed when a user selects the “analysts' dogs” button (not shown). Web page 220 presents, in tabular form, the names of individual instruments sold in a relevant time period by predetermined percentages (in this case, 20%, 15%, 10% and 5%) of the licensed investment analysts who are members of the web site. This page can give insight into what equities, or other instruments, are in disfavor. Thus, a visitor to the web site may request collective information concerning the investment instruments whose representation in the various portfolios has been decreased (or even entirely sold off) most often, during a preceding time period.

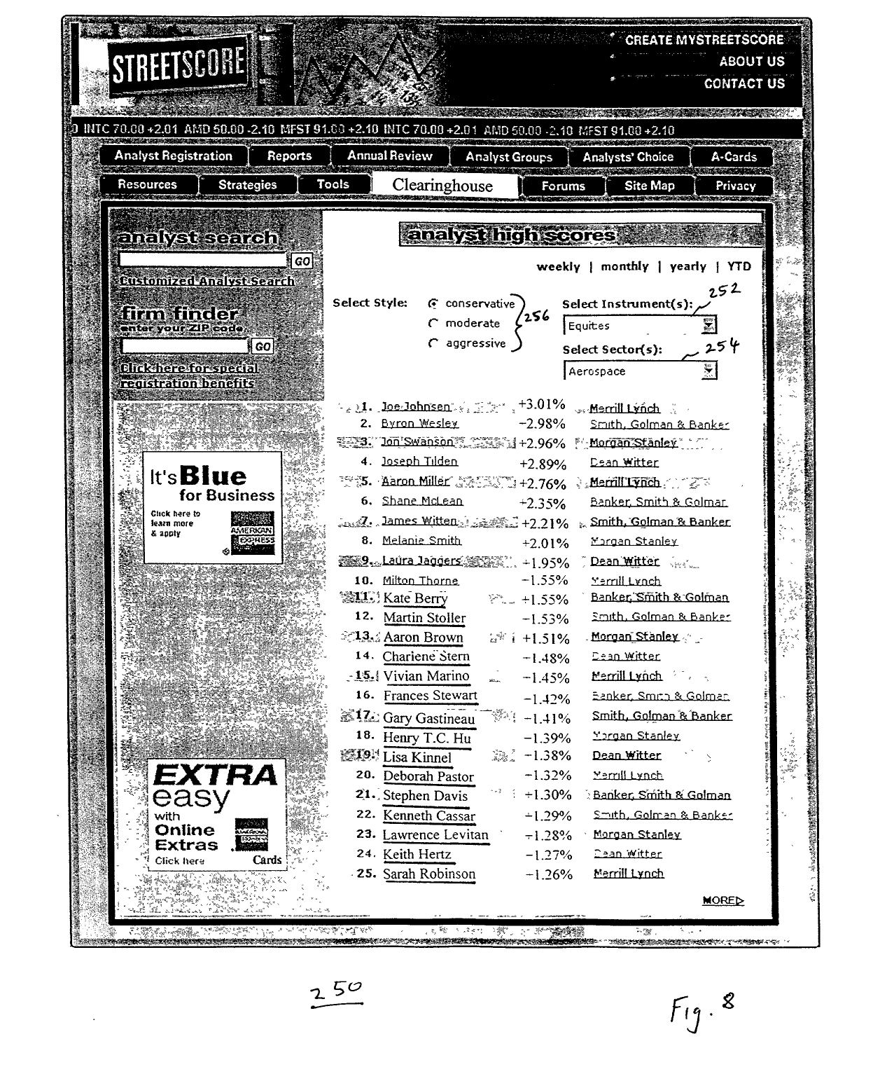

FIG. 8 depicts a web page 250 showing the analyst high scores given a specific investment type 252, a particular industry sector 254 and a particular investment risk level 256. The content of the analyst high scores for the selected combination of investment portfolio characteristics includes the licensed investment analysts' names, their respective returns over a predetermined time period, and the investment firm with which they are affiliated. Web page 250 typifies the result of clicking on the “go to analyst high score” link 258 seen in web page 180 of FIG. 5.

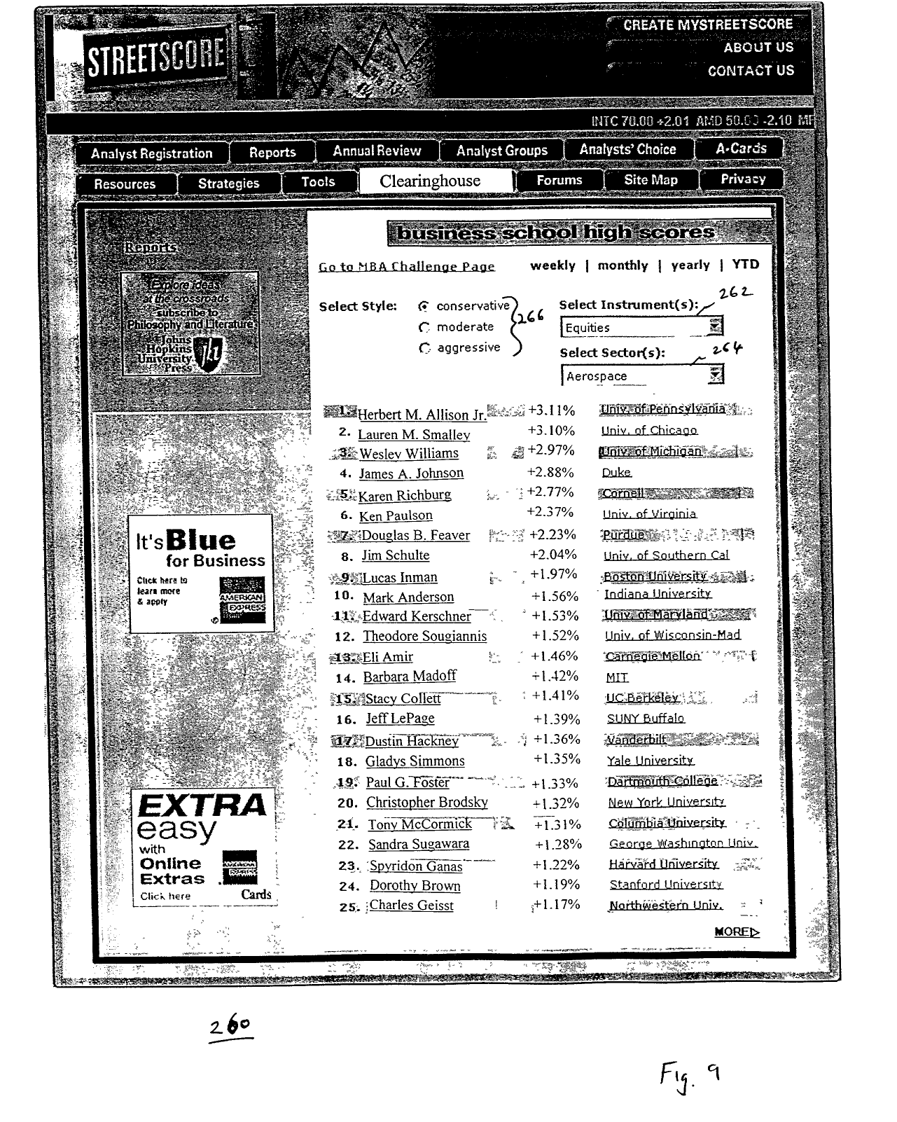

FIG. 9 depicts a web page 260 showing the business school students' high scores given a specific investment type 262, a particular industry sector 264, and a particular investment risk level 266. The content of the business school students' high scores for the selected combination of investment portfolio characteristics includes the students' names, their respective returns over a predetermined time period, and the business school with which they are affiliated. Thus, web page 260 is the MBA student counterpart to licensed investment analyst web page 250, and the same type of information available for a licensed investment analyst and his/her firm, is available for the MBA students.

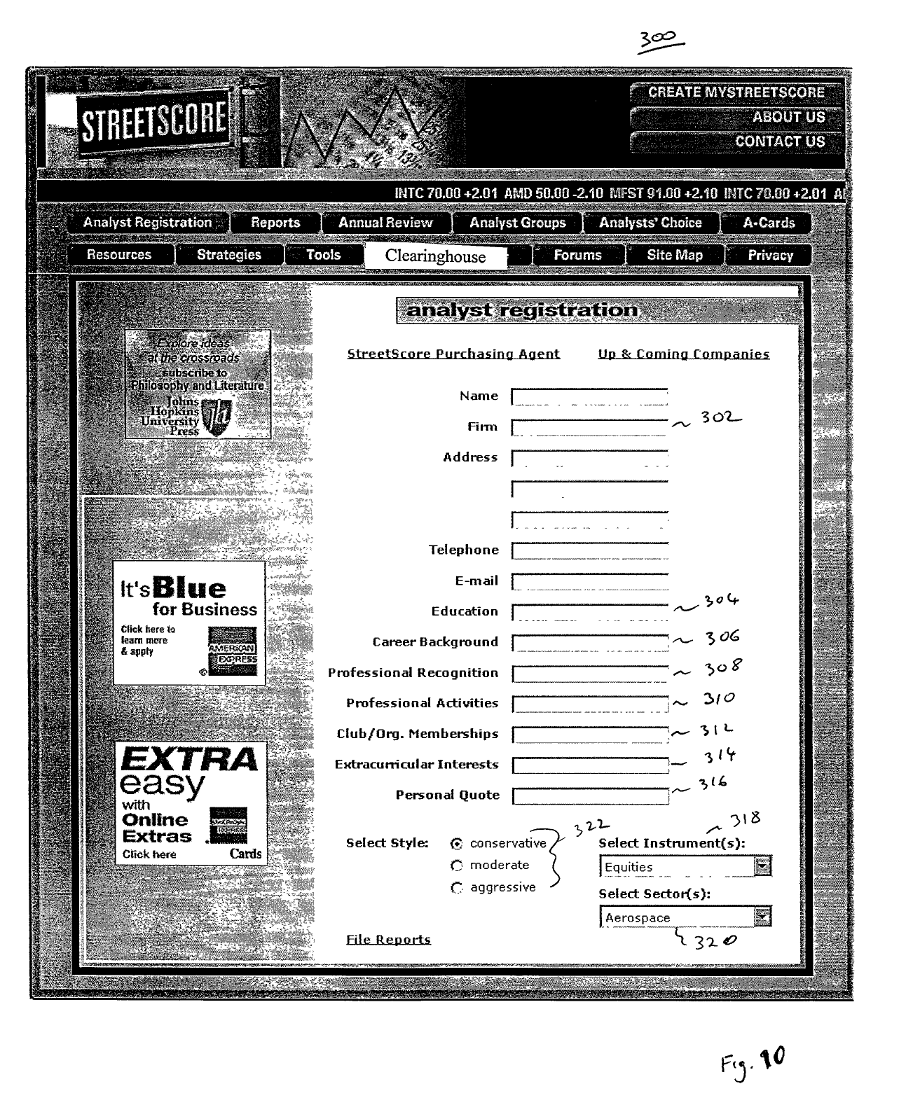

FIG. 10 presents a web page comprising an analyst registration form 300. The analyst registration form asks a prospective analyst for identifying information, including the name of the investment firm 302 with which he or she is associated. Additional biographical information such as educational background 304, professional experience 306, professional achievements 308, professional activities 310, various affiliations 312, interests 314 and a personal quote 316, are also requested. Each analyst is also asked to select at least one set of investment portfolio characteristics, by specifying the investment type 318 the industry sector in which he or she is interested 320 and the preferred investment risk level 322. It is understood that an analyst may choose to create more than one portfolio by selecting a plurality of sets of investment portfolio characteristics. Thus, a licensed investment analyst who has registered with the web site may submit multiple portfolios, one for each combination of investment types, industry sectors, and investment risk levels. In the case of business school students, a registration form not unlike form 300 of FIG. 10 is provided, except that it asks for a school, rather than a firm in window 302, and preferably also asks for academic information, such as program of study, grade point average, and location preferences, all of which would be of interest to investment firms, among others, seeking new employees.

Upon receiving the registration information from a prospective licensed investment analyst, the servers associated with the host web site must verify that the individual is indeed affiliated with the professional firm designated in space 302. This may be done by transmitting a request to a server or other device associated with each of the investment firms, to verify the affiliation with the named investment analyst. This process may be arranged for in advance between the host web site and the various investment firms expressing an interest in having their own licensed investment analysts participate as members on this web site.

Once an analyst has registered with the web site, and his or her credentials have been verified, that analyst can then fully participate in the web site. To do this, for each set of investment portfolio characteristics that that analyst has specified, the analyst selects a basket of equities or other financial instruments (e.g., bonds) whose then-market price totals a predetermined amount, for example, $100,000. The basket of securities and/or other financial instruments must satisfy the characteristics of investment type (e.g., stocks, bonds, currency) the industry sector (biotechnology, computers, pharmaceuticals, etc.) and the investment risk level (conservative, moderate, or aggressive). With respect to investment risk level, the web site makes a calculation of a weighted beta, based upon the portfolio selected by the licensed investment analyst, and the published beta values for each of the instruments selected. For those instruments not having an associated beta value or equivalent, other volatility indices, either published, or created by the web site, can be used. If the calculation indicates that the weighted beta (or other volatility index) is not consonant with the designated investment risk level, an error indication will be sent to the licensed investment analyst, advising that analyst to either alter his or her selections or change the investment risk level characteristic that he or she has selected. An investment analyst is permitted to select more than one basket of investment instruments and, in general, may submit as many baskets as there are possible combinations among the investment portfolio characteristics.

While each of the portfolios described above corresponds to a single instrument type, a single industry sector, and a single risk level, it should be kept in mind that an analyst may assemble a “composite” portfolio—in effect, a portfolio of “mini-portfolios”. Thus, an analyst may choose to allocate the $100,000 initial amount over two or more portfolios, each portfolio being assembled in accordance with the triplet of instrument type, industry sector and risk level. For example, an analyst may create a first portfolio from equities in the biotechnology sector having a moderate risk level, and a second portfolio from corporate-issued bonds issued in the utilities industry having low risk level, the initial cost of the first portfolio and the second portfolio totaling $100,000. As another example, an analyst may choose two or more portfolios, all of which comprise equities in different industry sectors. As yet another example, an analyst may choose to distribute the $100,000 over a first portfolio comprising equities, a second comprising bonds, and a third comprising another investment instrument type, such as futures. It should be evident to one skilled in the art that a virtually unlimited number of such allocations are possible, to form such portfolios of mini-portfolios.

The performances of the analysts assembling such composite portfolios may be presented in a number of ways. For example, one may view the performance of all analysts assembling composite portfolios, regardless of the type and allocation of the initial amount among the various mini-portfolios. Alternatively, one may view only the performances of analysts who have assembled particular types of mini-portfolios—e.g., the top analysts who have composite portfolios comprising a particular equities industry sector mini-portfolio, and a mini-portfolio of bonds issued by a specific type of issuer, e.g., foreign governments. It should be evident to one skilled in the art that the performances of the top analysts may be presented in a virtually limitless number of ways.

FIG. 11 shows a user registration web page 330 which a user of the web site may fill out. Apart from conventional personal identifying information 332, the user of the web site is asked to specify the investment type 334 in which he/she is interested, industry sectors 336 in which he/she is interested and an investment risk level 338 with which he/she feels comfortable. This information helps target content that would be of interest to a particular user, and also can help refer a user to one or more appropriate licensed investment analysts who are members of the site and specialize in investment portfolios consistent with the investment objectives of the user. Preferably, there is no requirement that a user fill out a registration form to use the web site for the purpose of viewing the performances of the licensed investment analysts. Hence, a user may browse through the web site and make avail of its information content without having to reveal any identifying information. To encourage visitors of the web site to register, page 330 further includes a special registration benefits link 340 to direct the visitor to a page detailing various rewards for registering. These rewards can include such things as free investment consultation sessions with a registered analyst in their area, and the like. Visitors to page 330 may also select a reports button 342 to gain access to various reports and other documents concerning investment strategies, and the like.

In essence, the present invention provides both licensed investment analysts, business schools, or other institutions or individuals, for example, MBA students, with a contest to demonstrate their prowess in assembling investment portfolios. In addition to simply viewing the performance of various such contestants over varying time periods and for a particular set of investment portfolio characteristics, a user of the web site can explore in detail the decisions made by such contestants. Thus, by clicking on a link for detailed information 176 (see FIG. 4), a user can view some, or all of the history of exchanges made by an analyst from the inception of the initial investment of $100,000. It can thus show the amounts and dates of the initial purchases as well as subsequent exchanges made by that analyst for the portfolio associated with that set of investment portfolio characteristics. The same holds for the investment portfolios of the business school students. Additional material which may be obtained by clicking on the “Detailed Information” link 176 may include reports created by the analyst/contestant explaining his or her reasoning for making each trade. These reports can provide valuable insight into the decision-making process engaged in by a participant in such a contest. Thus, the detailed information effectively provides a diary memorializing the trades, along with the reasons behind these trades.

In general, the same type of information available for a licensed investment analyst and his/her firm, is available for an MBA student and his/her school. This includes such things as biographical information on an “MBA student card”, much like the aforementioned “analyst card”, MBA student groups with links to high scores and reports, historical performance, MBA students' choice of widely held stocks or other instruments, widely recently sold stocks or other instruments, detailed information about trades, and so forth.

Yet another feature of a web site in accordance with the present invention are various bulletin boards and fora for people interested in investments to post and review messages. One such forum may serve the role of a bulletin board to be used to disclaim rumors about, or comment on statements or actions allegedly made by, a legal entity such as an investment analyst, investment firm, corporation, or the like. This would permit such an individual, investment firm, or other company, such as one whose shares or bonds are traded, to combat rumors spread on various Internet chat boards, including rumors concerning statements which have been wrongly attributed to its employees and agents. This can be done by posting a message to a “clearinghouse” bulletin board, the message perhaps comprising a clarification, denial, or rebuttal.

The messages posted in the clearinghouse forum are responses from a legal entity attempting to dispel a rumor about, or comment on a statement or action attributed to, that entity. Therefore, an individual attempting to post messages in such a forum must be so authorized. Accordingly, to post a message directed to subjects concerning that entity, the web site must first receive login information from a user authorized to post messages on behalf of said legal entity, then receive a request to post a message to an “area” within said forum, posting to said area being limited to individuals authorized to post messages on behalf of said legal entity, and finally receive from that individual and then store the message pertaining to the rumor, statement, or action.

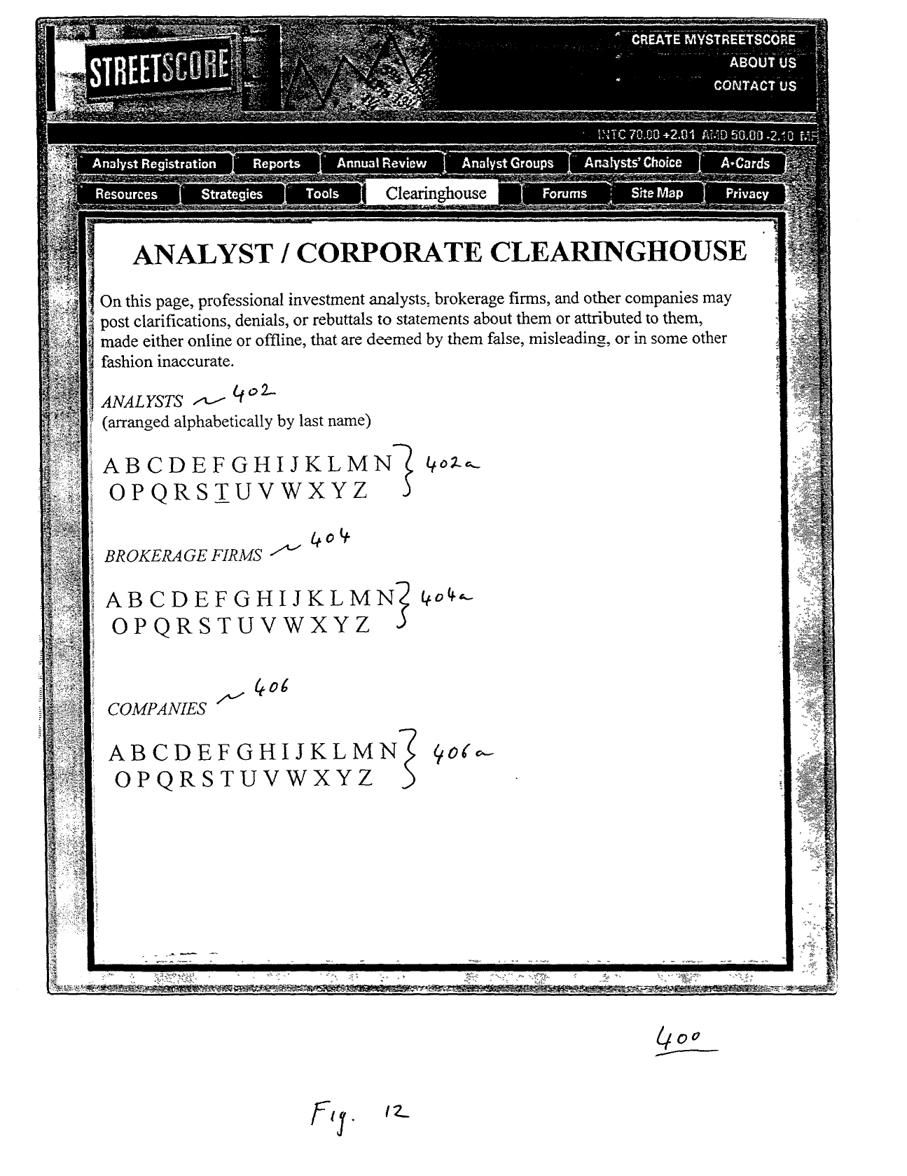

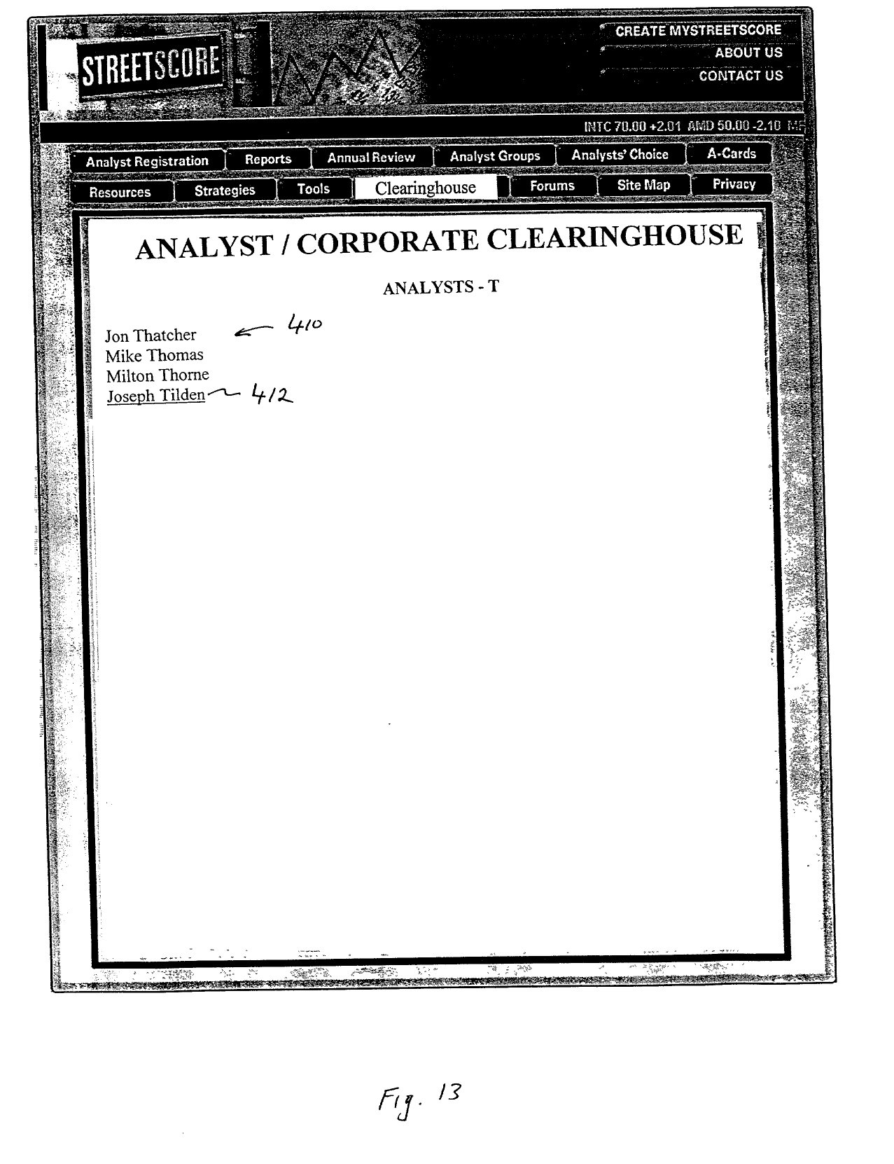

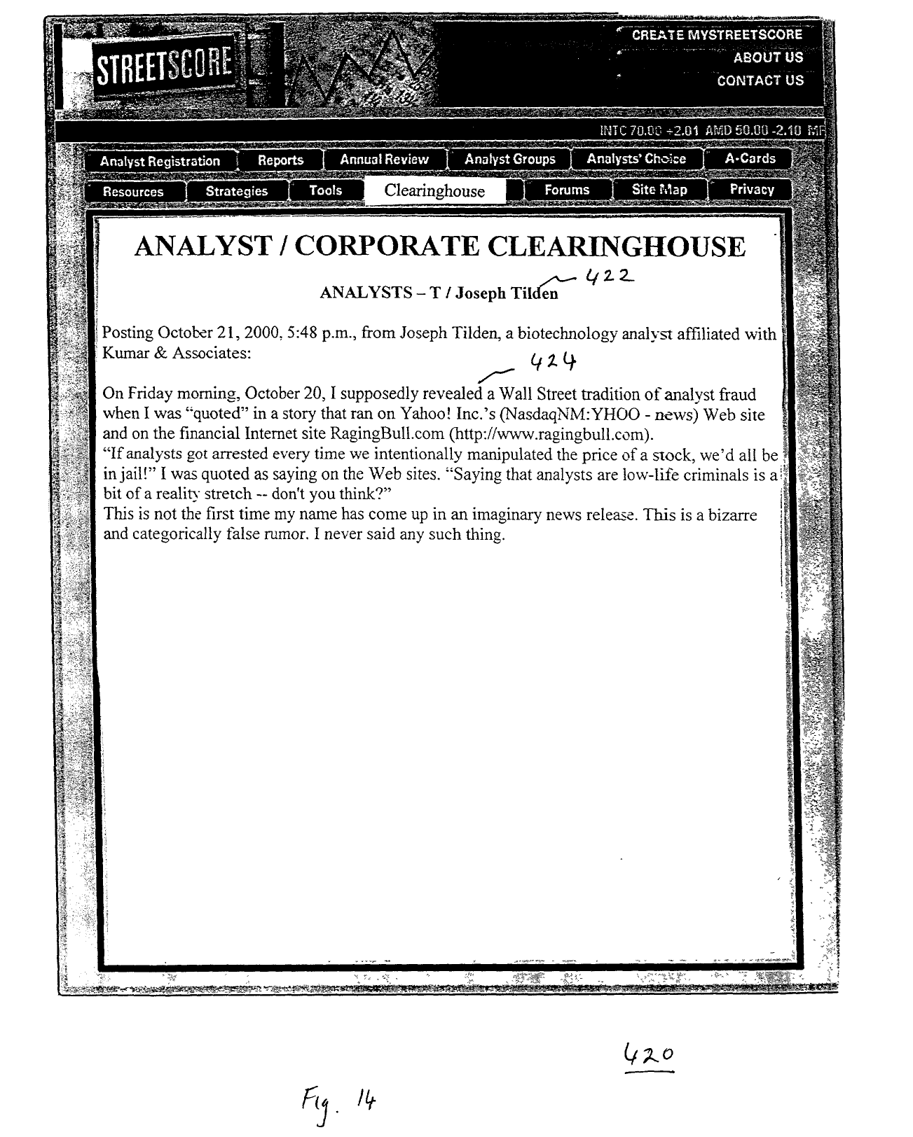

FIG. 12 shows a clearinghouse directory page 400 listing an analyst category 402, an investment firm category 404 and a company category 406. A visitor to the directory page may click on a corresponding alphabet menu 402a, 404a, 406a to specify an initial associated with the name of a member within each category—e.g., the first letter of the last name of an individual analyst, or the first letter of an investment firm or company. Alternatively, pull-down menus, or windows may be provided for the same purpose. FIG. 13 shows a clearinghouse analyst list 410 for analysts whose last names start with the letter “T”. FIG. 14 shows a posting on the web site for the analyst named “Joseph Tilden” 412, selected from the clearinghouse analyst list 410. As seen in FIG. 14, a clearinghouse message page 420 corresponds to a single member 422 (in this case, analyst Joseph Tilden), and includes a posting 424 submitted by Joseph Tilden, regarding quotes attributed to him.

Registered users/recipients may be notified by electronic means each time a new entry pertaining to a specific legal entity, such as a company, is made to the clearinghouse. This allows a user to keep abreast of new information about a company of particular interest to that user. Preferably, the recipient is notified by e-mail having an embedded link therein, which the recipient can ‘click’ on to open a browser window (if one is not already open) and receive the newly added clearinghouse content. Alternatively, the e-mail may include the newly added clearinghouse content itself. The user may instead be notified only upon logging on the web site, whereupon the user may choose to visit the web site. However, to receive such notifications, a user/recipient must first register with the web site and indicate the companies or other entities about which he or she wishes to receive clearinghouse updates.

The return on investment posted for each licensed investment analyst or business student may be compared to the return of the S&P 500 or other comparable, recognized index, posted on each page on which performance information appears. Additionally, a comparison with a random selection of like investment types comprising a portfolio may also be provided. This essentially allows one to compare the performance of a licensed investment analyst or business student with a haphazard methodology. Such comparisons theoretically would establish the superiority of the licensed investment analysts, business schools, MBA students, etc. in portfolio management. In such a random portfolio, exchanges can be made at random times or, alternatively, at pre-determined time intervals. In addition, the particular investment instrument sold and the new investment instrument purchased may also be selected at random during these exchanges. To establish a common baseline of comparison, however, the random portfolio preferably corresponds to the same set of investment portfolio characteristics as those of the analyst's portfolio being displayed, and preferably also presents the return for the same time period. This allows one to compare the return on the random portfolio with the corresponding statistic for the analyst's portfolio while minimizing variation due to underlying portfolio characteristics.

Finally, while the present invention has been described with reference to certain preferred embodiments, it should be kept in mind that the invention is not limited to these. Variations of the above may well be within the present invention, whose extent is given by the scope of the claims presented below.

What is claimed is:

1. A computer-implemented method for providing investment performance information of an investment analyst, the method comprising the steps of:
receiving registration information from a prospective investment analyst, the registration information including information specifying an entity with which the prospective investment analyst is professionally affiliated and designating at least one qualification of the prospective investment analyst;
verifying that the prospective investment analyst is indeed associated with the specified entity and meets the designated qualification, to thereby register the prospective investment analyst as a registered investment analyst;
receiving, from the registered investment analyst, at least one investment portfolio characteristic;
receiving, from the registered investment analyst, a portfolio of selections including a quantity of each of a plurality of investment instruments comprising the portfolio, the portfolio being not greater than a predetermined total fictional-dollar value and the investment instruments being consistent with that registered investment analyst's corresponding portfolio characteristic; and
subsequently transmitting a statistic reflective of an investment return of the portfolio, along with information identifying the registered investment analyst.

2. The method according to claim 1, wherein the at least one investment portfolio characteristic includes one from the group consisting of investment types, industry sectors and investment risk levels.

3. The method according to claim 1, further comprising the steps of receiving trade information from the registered investment analyst to modify quantities of at least one investment instrument within the portfolio.

4. The method according to claim 3, further comprising the step of transmitting detailed information concerning trades made by the registered investment analyst which modify the portfolio.

5. The method according to claim 4, wherein the detailed information includes a registered investment analyst's reasoning for making at least one trade.

6. The method according to claim 1, further comprising the step of transmitting the name of the entity with which the registered investment analyst is associated, along with an electronic link directing one to further information about that entity.

7. The method according to claim 1, further comprising the step of transmitting an electronic link directing one to further information about the registered investment analyst.

8. The method according to claim 7, wherein the further information about the registered investment analyst includes a picture of the registered investment analyst.

9. The method according to claim 7 wherein the further information about the registered investment analyst includes biographical data about the registered investment analyst.

10. The method according to claim 1 wherein the entity is an investment firm, and the designated qualification is that the prospective investment analyst is professionally licensed.

11. The method according to claim 1 wherein the entity is a business school and the designated qualification is that the prospective investment analyst is a student at that business school.

12. The method according to claim 1, further comprising the step of also transmitting an investment return based on a random basket of investment instruments having the same at least one portfolio characteristic as that associated with said statistic.

13. A computer-implemented method for first acquiring and then providing information about fictional investment portfolios assembled by investment analysts, comprising the steps of:
receiving registration information from each of a plurality of prospective investment analysts, the registration information including information specifying an entity with which that prospective investment analyst is professionally affiliated and designating at least one qualification of the prospective investment analyst;
verifying that each prospective investment analyst is indeed associated with the specified entity and meets the designated qualification, to thereby register each prospective investment analyst as a registered investment analyst;
receiving, from each registered investment analyst, at least one investment portfolio characteristic;
receiving, from each registered investment analyst, at least one portfolio comprising a quantity of each of a plurality of investment instruments, the portfolio being subject to a predetermined total value and the investment instruments being consistent with that registered investment analyst's corresponding portfolio characteristic;
receiving a request for collective information concerning the investment portfolios of the registered investment analysts; and
transmitting said collective information, in response to said request.

14. The method according to claim 13, comprising the step of transmitting, as the collective information, at least one list of investment instruments that are most widely held among the registered investment analysts.

15. The method according to claim 14, comprising the step of transmitting, as the collective information, a plurality of lists of investment instruments, each list grouping investment instruments according to a particular range of proportions of registered investment analysts holding those particular investment instruments.

16. The method according to claim 15, comprising the step of transmitting, as the collective information, at least one list of investment instruments whose representation in the portfolios of the registered investment analysts has been decreased most frequently, within a preceding time period.

17. The method according to claim 16, comprising the step of transmitting, as the collective information, a plurality of lists of investment instruments, each list grouping investment instruments according to a particular range of proportions of registered investment analysts who have decreased their holdings of those particular investment instruments, within a preceding time period.

18. The method according to claim 13, comprising the step of transmitting, as the collective information, investment performance information for each of a plurality of registered investment analysts having the highest investment returns, the registered investment analysts having said at least one investment portfolio characteristic in common.

19. The method according to claim 18, wherein the at least one investment portfolio characteristic includes one from the group consisting of investment types, industry sectors and investment risk levels.

20. The method according to claim 13, comprising the step of transmitting, as the collective information, investment performance information for each of a plurality of registered investment analysts having specific criteria in common, the specific criteria having been established by a requestor who requested the collective information.

21. The method according to claim 20, wherein the specific criteria comprise at least one boolean function of a plurality of individual criteria.

22. The method according to claim 20, wherein the specific criteria include geographical location information.

23. The method according to claim 13, comprising the step of transmitting, as the collective information, names of either investment firms or registered investment analysts having specific criteria in common, the specific criteria having been established by a requestor who requested the collective information.

24. The method according to claim 23, wherein the collective information further includes investment performance information.

25. The method according to claim 23, wherein the specific criteria comprise at least one boolean function of a plurality of individual criteria.

26. The method according to claim 23, wherein the specific criteria include geographical location information.

27. A computer-implemented method of operating a web-based forum for commenting on a rumor about, or on a statement or action attributed to, a legal entity, the rumor, statement, or action concerning financial matters, the method comprising the steps of:
receiving login information from a first user authorized to post messages on behalf of said legal entity, in said forum;
receiving, from said first user, a request to post a message to an area within said forum, posting to said area being limited to individuals authorized to post messages on behalf of said legal entity;
receiving from said first user and then storing, a message pertaining to said rumor, statement, or action;
subsequently receiving, from a second user, a request to view said message; and
transmitting said message, in response to said request to view said message.

28. The computer-implemented method according to claim 27, further comprising the step of sending e-mail to a registered recipient, whenever a new entry regarding a legal entity specified by said registered recipient has been made to said web-based forum, the email including a link to said new entry.

29. A computer-implemented method for providing investment performance information of an investment analyst, the method comprising the steps of:
receiving registration information from a prospective investment analyst, the registration information including information specifying an entity with which the prospective investment analyst is professionally affiliated and designating at least one qualification of the prospective investment analyst;
verifying that the prospective investment analyst is indeed associated with the specified entity and meets the designated qualification, to thereby register the prospective investment analyst as a registered investment analyst; receiving, from the registered investment analyst, at least one first investment portfolio characteristic;
receiving, from the registered investment analyst, a first portfolio of selections including a quantity of each of a plurality of investment instruments comprising the first portfolio, the investment instruments being consistent with that registered investment analyst's corresponding first portfolio characteristic;
receiving, from the registered investment analyst, at least one second investment portfolio characteristic;
receiving, from the registered investment analyst, a second portfolio of selections including a quantity of each of a plurality of investment instruments comprising the second portfolio, the investment instruments being consistent with that registered investment analyst's corresponding second portfolio characteristic, wherein the first and second portfolios together sum to an amount not greater than a pre-determined total fictional-dollar value; and
subsequently transmitting a statistic reflective of an investment return of a composite portfolio comprising the first and second portfolios, along with information identifying the registered investment analyst.

30. The computer-implemented method according to claim 29, further comprising:
receiving, from the registered investment analyst, at least one third investment portfolio characteristic;
receiving, from the registered investment analyst, a third portfolio of selections including a quantity of each of a plurality of investment instruments comprising the third portfolio, the investment instruments being consistent with that registered investment analyst's corresponding third portfolio characteristic, wherein the first, second and third portfolios together sum to an amount not greater than a pre-determined total fictional-dollar value.
